(19) United States
(12) Patent Application Publication
(10) Pub. No.: US 2024/0272929 A1
(43) Pub. Date: Aug. 15, 2024

(54) INFORMATION PROCESSING DEVICE, JOB EXECUTION SYSTEM, AND CONTROL METHOD

(71) Applicant: Mitsubishi Electric Corporation, Tokyo (JP)

(72) Inventor: Kenji ESUMI, Tokyo (JP)

(73) Assignee: Mitsubishi Electric Corporation, Tokyo (JP)

(21) Appl. No.: 18/570,080

(22) PCT Filed: Jun. 30, 2021
(86) PCT No.: PCT/JP2021/024736

§ 371 Date: Dec. 14, 2023

(51) Int. Cl. G06F 9/455

(52) U.S. Cl. CPC G06F 9/45558; G06F 2009/45562; G06F 2009/45575

(57) ABSTRACT

A server receives a job execution request transmitted from a management device and indicating a request for executing a job. The server includes an instance that executes the job indicated by the job execution request, a monitoring unit that monitors a state of connection with the management device, and an instance control unit that executes stoppage of the instance or discarding of the instance when the instance is in operation or in an operable state and the connection state is a disconnected state.

### TECHNICAL FIELD

The present disclosure relates to an information processing device, a job execution system and a control method.

### BACKGROUND ART

Cloud services are becoming widespread in recent years. In the cloud service, resources such as databases, storage and applications can be used. A great number of resources are used in the cloud and data processing is executed distributedly, thus a great number of jobs are processed at the same time.

Further, an “instance” is constructed by using resources. An example of the instance is a virtual computer, for example. Incidentally, the virtual computer is referred to also as a virtual machine.

Here, automation of a great amount of work is being requested. When a great amount of work is automated, it is necessary to process a great amount of jobs. In such a circumstance, there has been proposed a technology that implements a job execution agent for executing the jobs by an instance (see Patent Reference 1).

### PRIOR ART REFERENCE

### Patent Reference

Patent Reference 1: Japanese Patent Application Publication No. 2014-186416

### SUMMARY OF THE INVENTION

### Problem to be Solved by the Invention

Incidentally, the instance is constructed in a server. When a job execution request is received from a device such as a household electrical appliance, the instance executes a job indicated by the job execution request. Additionally, the fee is continuously charged in a state in which the instance has been activated (hereinafter referred to as an activated state).

When the device transmits an instance stoppage request to the server, the instance is stopped. Due to the stoppage of the instance, the charging of the fee in the activated state stops. Here, there are cases where the server does not receive the stoppage request. For example, a user can turn off the power of the device without paying attention to the state of the instance. As a result, the device does not transmit the stoppage request and accordingly the server does not receive the stoppage request. Further, the server does not receive the stoppage request when a failure has occurred a network between the device and the server, for example.

When the server does not receive the stoppage request as above, the activated state continues and accordingly the charging of the fee in the activated state continues. The continuation of the charging of the fee increases the cost burden on the user.

An object of the present disclosure is to hold down the cost.

### Means for Solving the Problem

An information processing device according to an aspect of the present disclosure is provided. The information processing device receives a job execution request transmitted from a management device and indicating a request for executing a job. The information processing device includes an instance that executes the job indicated by the job execution request, a monitoring unit that monitors a state of connection with the management device, and an instance control unit that executes stoppage of the instance or discarding of the instance when the instance is in operation or in an operable state and the connection state is a disconnected state.

### Effect of the Invention

According to the present disclosure, the cost can be held down.

### BRIEF DESCRIPTION OF THE DRAWINGS

FIG. 1 is a diagram showing a job execution system.

FIG. 2 is a diagram showing hardware included in a management device.

FIG. 3 is a block diagram showing functions of the management device and a server.

FIG. 4 is a diagram showing an example (No. 1) of a time line in the job execution system.

FIG. 5 is a sequence diagram of a process executed in the job execution system.

FIG. 6 is a diagram showing an example (No. 2) of the time line in the job execution system.

### MODE FOR CARRYING OUT THE INVENTION

An embodiment will be described below with reference to the drawings. The following embodiment is just an example and a variety of modifications are possible within the scope of the present disclosure.

### Embodiment

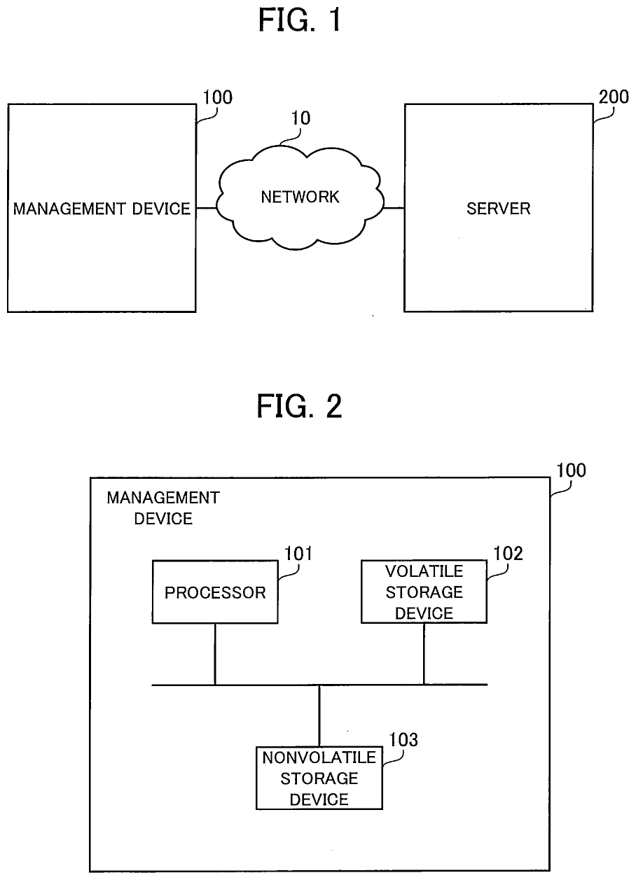

FIG. 1 is a diagram showing a job execution system. The job execution system includes a management device 100 and a server 200. The management device 100 and the server 200 are connected to each other via a network 10. The network 10 is a wired network or a wireless network.

The management device 100 is a device that manages jobs. For example, the management device 100 is a household electrical appliance or the like. The household electrical appliance is an instrument used by a user. The management device 100 includes a power supply. When the power supply is in an on state, the management device 100 operates. When the power supply is in an off state, the management device 100 stops the operation.

The server 200 is a device that executes a control method. The server 200 is a cloud server. The server 200 is referred to also as an information processing device. In FIG. 1, the number of servers is one. The number of servers can also be two or more. In short, functions of the server 200 are implemented by one or more servers. The server 200 is capable of constructing an instance by using resources of the server 200.

Further, the number of management devices can also be two or more. Then, a plurality of management devices may make use of one instance.

Next, hardware included in the management device 100 and the server 200 will be described below.

FIG. 2 is a diagram showing the hardware included in the management device. The management device 100 includes a processor 101, a volatile storage device 102 and a nonvolatile storage device 103.

The processor 101 controls the whole of the management device 100. The processor 101 is a Central Processing Unit (CPU), a Field Programmable Gate Array (FPGA) or the like, for example. The processor 101 can also be a multiprocessor. Further, the management device 100 may include a processing circuitry. The processing circuitry may be either a single circuit or a combined circuit.

The volatile storage device 102 is main storage of the management device 100. The volatile storage device 102 is a Random Access Memory (RAM), for example. The nonvolatile storage device 103 is auxiliary storage of the management device 100. The nonvolatile storage device 103 is a Hard Disk Drive (HDD) or a Solid State Drive (SSD), for example.

The server 200 includes a processor, a volatile storage device and a nonvolatile storage device similarly to the management device 100. Further, the server 200 may include a processing circuitry.

The server 200 receives an instance control request from the management device 100. When the instance control request is received, the server 200 executes generation, activation, stoppage or discarding of an instance. Here, the generation, the activation, the stoppage and the discarding of an instance will be explained below.

First, the generation of an instance will be explained below. When an instance generation control request is received from the management device 100, the server 200 sets resources such as an Operating System (OS), a processor to be used, and a volatile storage device. By this, the resources are reserved. Based on the contents of the resource reservation, the server 200 generates a storage image file of an instance (i.e., virtual computer). The server 200 stores the storage image file in the nonvolatile storage device of the server 200. In the state in which the storage image file has been stored, the fee is continuously charged. The fee in the state in which the storage image file has been stored is generally cheaper than the fee when the instance is activated. After the storage image file is stored, the instance shifts to a stopped state.

The activation of the instance will be explained below. When an instance activation control request is received from the management device 100, the server 200 activates the instance based on the storage image file. Accordingly, the instance shifts from the stopped state to an activating state. When an activation process of the instance is completed, the instance shifts from the activating state to an activated state. The fee per unit time varies depending on the amount of assigned resources. The unit fee increases with the increase in the performance of the instance.

The stoppage of the instance will be explained below. When the server 200 receives an instance stoppage control request from the management device 100, the instance shifts from the activated state to a stopping state. When the instance has shifted to the stopping state, a stoppage process of the instance is executed in the server 200. When the stoppage process of the instance is completed, the instance shifts from the stopping state to the stopped state. Incidentally, in the stopped state, the storage image file is stored in the nonvolatile storage device of the server 200. Therefore, the fee is continuously charged.

Further, files or the like written in during the period from the activated state to the stopping state have been incorporated into the storage image file. Therefore, at the next activation of the instance, the server 200 is capable of reactivating the instance based on the storage image file.

The discarding of the instance will be explained below. When the server 200 receives an instance discarding control request from the management device 100, the server 200 executes a discarding process of the instance. The server 200 releases the resources reserved in the instance generation such as the OS, the used processor and the volatile storage device.

Next, functions of the management device 100 and the server 200 will be described below.

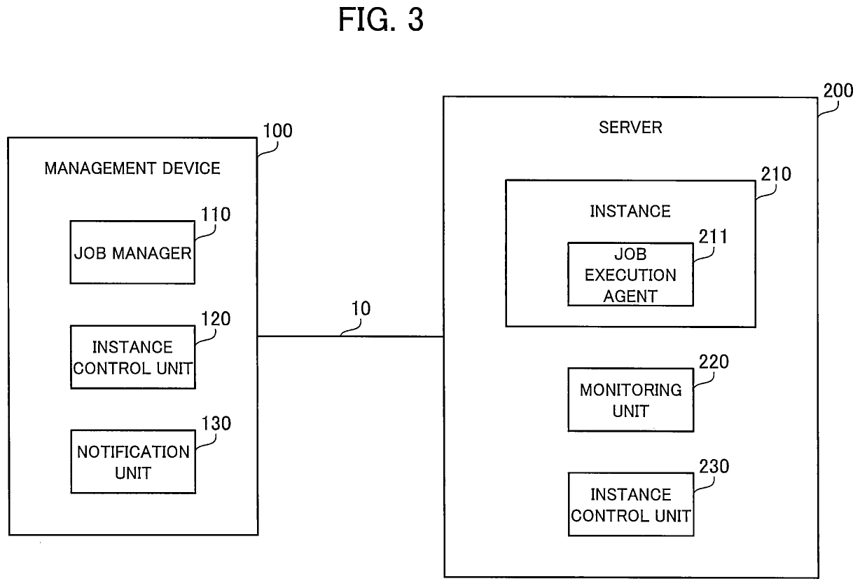

FIG. 3 is a block diagram showing the functions of the management device and the server. The management device 100 includes a job manager 110, an instance control unit 120 and a notification unit 130.

Part or all of the job manager 110, the instance control unit 120 and the notification unit 130 may be implemented by a processing circuitry. Further, part or all of the job manager 110, the instance control unit 120 and the notification unit 130 may be implemented as modules of a program executed by the processor 101.

When a job request is received from a non-illustrated request unit, the job manager 110 calculates an instance number for having the job executed. The job manager 110 transmits an activation control request for the instance number to the instance control unit 120. Incidentally, the job indicated by the job request is a job of an instrument control process, a job indicating simulation computation for making an instrument operate efficiently, or the like. Further, the job manager 110 transmits a state notification start request to the notification unit 130.

The instance control unit 120 transmits the instance control request to the server 200. Further, the instance control unit 120 transmits an instance state request to the server 200. By this, the instance control unit 120 may receive instance state information from the server 200.

Furthermore, when the activation control request for the instance number is received from the job manager 110, the instance control unit 120 transmits an instance activation control request for the instance number to the server 200.

When the notification unit 130 receives the state notification start request from the job manager 110, the notification unit 130 is enabled to transmit information indicating the state of the management device 100 to the server 200. When a state request is received from the server 200, the notification unit 130 transmits the information indicating the state of the management device 100 to the server 200.

The server 200 includes an instance 210, a monitoring unit 220 and an instance control unit 230. Part or all of the monitoring unit 220 and the instance control unit 230 may be implemented by a processing circuitry included in the server 200. Further, part or all of the monitoring unit 220 and the instance control unit 230 may be implemented as modules of a program executed by the processor included in the server 200.

The instance 210 operates as a job execution agent 211. The instance 210 receives a job execution request transmitted from the management device 100.

Incidentally, the job execution request indicates a request for executing a job. When the job execution request is received from the management device 100, the instance 210 executes the job indicated by the job execution request. Incidentally, the job is a job indicating simulation computation, for example, as mentioned earlier.

Incidentally, FIG. 3 shows one instance. A plurality of instances may be constructed in the server 200. The plurality of instances may parallelly compute one job. By this, the result is obtained in a short time. Further, the plurality of instances may also parallelly compute a plurality of jobs.

The monitoring unit 220 monitors the state of connection with the management device 100. For example, the monitoring unit 220 monitors the connection state by using a PING command. The monitoring unit 220 is capable of detecting the connection state by periodically transmitting the PING command to the management device 100.

The monitoring unit 220 may receive an instance operating time from the management device 100. The instance operating time indicates an operating time for which the instance 210 can operate. For example, the instance operating time indicates a remaining time (e.g., 15 minutes left) for which the instance 210 can operate. Alternatively, for example, the instance operating time indicates a time of day until when the instance 210 can operate. For example, the instance operating time indicates that the instance 210 can operate until 3 p.m. Based on the instance operating time (referred to also as a first instance operating time, for example), when the server 200 does not receive the next instance operating time (referred to also as a second instance operating time, for example) until the elapse of an operating time indicated by the instance operating time, the monitoring unit 220 judges that the connection state is a disconnected state.

Further, the monitoring unit 220 transmits the state request to the management device 100. By this, the monitoring unit 220 may receive the information indicating the state of the management device 100 from the management device 100.

When the instance control request is received from the management device 100, the instance control unit 230 executes the generation, the activation, the stoppage or the discarding of an instance. For example, when the instance activation control request is received, the instance control unit 230 activates the instance 210 in the stopped state. Further, when the instance 210 has not been generated at the time point of receiving the instance activation control request, the instance control unit 230 executes an instance generation process and an instance activation process.

When the instance 210 is in operation or in an operable state and the connection state is the disconnected state, the instance control unit 230 executes the stoppage of the instance 210 or the discarding of the instance 210. Incidentally, the case where the connection state is the disconnected state may be represented also as a case where it is judged that the management device 100 and the server 200 are not connected to each other via the network 10.

Alternatively, the instance control unit 230 may execute the stoppage of the instance 210 or the discarding of the instance 210 when the instance 210 is in operation or in the operable state and the disconnected state has continued for a previously set time.

When the instance 210 has been stopped, the storage can be restored to the storage condition before the stoppage after the next instance activation control request is received. Thus, when the instance 210 has been stopped, the execution of the uncompleted job can be continued. However, the usage fee of the storage is continuously charged. In contrast, when the instance 210 has been discarded, the storage cannot be restored to the storage condition before the stoppage. However, the usage fee of the storage is not charged.

Here, it is permissible even if at least one of the monitoring unit 220 and the instance control unit 230 is included in the instance 210. Further, in cases where a plurality of instances are constructed, the monitoring unit 220 and the instance control unit 230 may be included in an instance other than the instance 210.

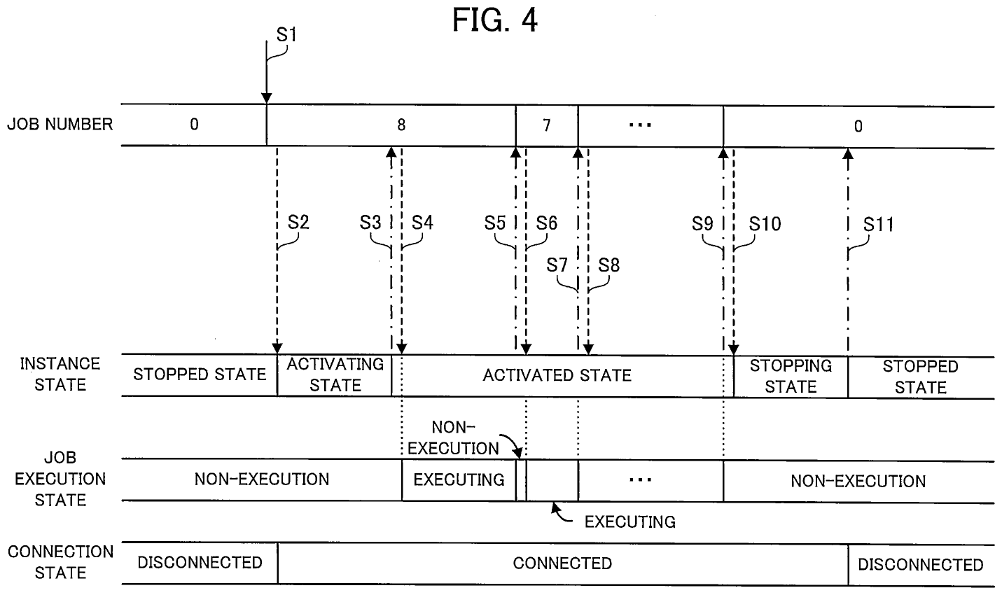

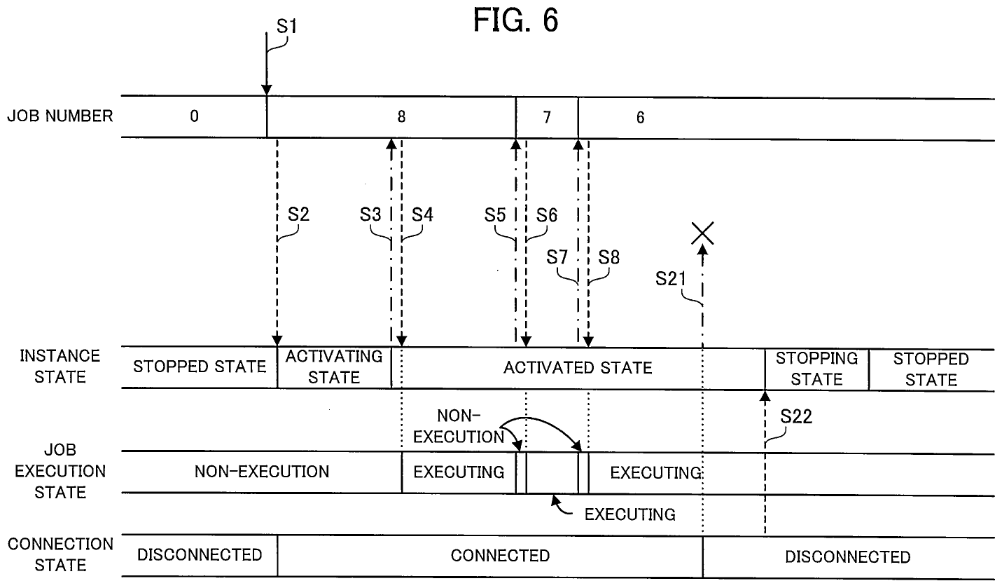

Next, examples of a time line in the job execution system will be described below. As mentioned earlier, there are cases where the state of connection with the management device 100 shifts to the disconnected state when the instance 210 is in the activated state. A case where the connection state does not shift to the disconnected state when the instance 210 is in the activated state will be explained with reference to FIG. 4. A case where the connection state shifts to the disconnected state when the instance 210 is in the activated state will be explained later with reference to FIG. 6.

FIG. 4 is a diagram showing an example (No. 1) of the time line in the job execution system. FIG. 4 shows the job number, the instance state, a job execution state and the connection state managed by the job manager 110.

First, the job number is 0 since no job has occurred. The instance state is the stopped state. Since no instance is operating, the job execution state is a non-execution state. Since the management device 100 and the server 200 are not communicating with each other, the connection state is the disconnected state.

(Step S1) The job manager 110 receives the job request from the request unit. The job number indicated by the job request is 8.

(Step S2) The instance control unit 120 establishes connection between the management device 100 and the server 200. Accordingly, the connection state shifts from the disconnected state to a connected state. The instance control unit 120 transmits the instance activation control request to the server 200.

(Step S3) The instance control unit 230 activates the instance 210. Accordingly, the instance state shifts from the stopped state to the activating state. Then, when the activation of the instance 210 is completed, the instance state shifts from the activating state to the activated state. The instance control unit 230 transmits an instance activation completion notification to the management device 100.

Incidentally, in cases where the management device 100 is a household electrical appliance, there exists a home gateway or a router between the management device 100 and the server 200. Thus, in the cases where the management device 100 is a household electrical appliance, the management device 100 and the server 200 do not directly communicate with each other. When the direct communication is impossible, there is a possibility that the management device 100 cannot receive the instance activation completion notification. Thus, when the direct communication is impossible, the management device 100 is capable of detecting that the instance 210 is in the activated state by periodically transmitting the instance state request to the server 200. When the activated state of the instance 210 is detected, the management device 100 detects that the activation of the instance is completed.

(Step S4) The instance control unit 120 transmits a job execution request to the server 200. Incidentally, the job execution request may include data to be used in a job. It is also possible for the instance control unit 120 to transmit the data to be used in the job to the server 200 before transmitting the job execution request.

(Step S5) The instance 210 (specifically, the job execution agent 211) executes the job. Accordingly, the job execution state shifts from the non-execution state to an executing state. Incidentally, the executing state means that the instance 210 is in operation.

When the execution of the job is completed, the job execution state shifts from the executing state to the non-execution state. Further, when the execution of the job is completed, the instance 210 transmits a job execution completion notification to the management device 100. Incidentally, the job execution completion notification includes an execution result of the job. The job manager 110 receives the job execution completion notification and decrements the job number by 1.

Here, the operable state will be explained below. The operable state is a state in which the instance state is the activated state and the job execution state is the non-execution state. In short, the operable state means a state in which the instance 210 is capable of immediately executing the operation upon receiving the job execution request.

(Step S6) The job manager 110 instructs the instance control unit 120 to transmit a job execution request since the job number is not 0. The instance control unit 120 transmits the job execution request to the server 200.

(Step S7) The instance 210 (specifically, the job execution agent 211) executes a job. Accordingly, the job execution state shifts from the non-execution state to the executing state.

When the execution of the job is completed, the job execution state shifts from the executing state to the non-execution state. Further, when the execution of the job is completed, the instance 210 transmits the job execution completion notification to the management device 100. The job manager 110 receives the job execution completion notification and decrements the job number by 1.

(Step S8) The job manager 110 instructs the instance control unit 120 to transmit a job execution request since the job number is not 0. The instance control unit 120 transmits the job execution request to the server 200.

As above, the management device 100 and the server 200 execute similar processes until the job number decreases to 0.

(Step S9) According to the job execution request, the instance 210 (specifically, the job execution agent 211) executes a job. Accordingly, the job execution state shifts from the non-execution state to the executing state.

When the execution of the job is completed, the job execution state shifts from the executing state to the non-execution state. Further, when the execution of the job is completed, the instance 210 transmits the job execution completion notification to the management device 100. The job manager 110 receives the job execution completion notification and decrements the job number by 1.

(Step S10) Since the job number is 0, the job manager 110 instructs the instance control unit 120 to transmit the instance stoppage request. The instance control unit 120 transmits the instance stoppage control request to the server 200.

(Step S11) The instance control unit 230 stops the instance 210. Accordingly, the instance state shifts from the activated state to the stopping state. Then, when the stoppage of the instance 210 is completed, the instance state shifts from the stopping state to the stopped state. The instance control unit 230 transmits an instance stoppage completion notification to the management device 100.

Incidentally, in the cases where the management device 100 is a household electrical appliance, the management device 100 may detect that the instance 210 is in the stopped state by periodically transmitting the instance state request to the server 200. When the stopped state of the instance 210 is detected, the management device 100 detects that the stoppage of the instance is completed.

Alternatively, when the job number is 0, the job manager 110 may instruct the instance control unit 120 to transmit the instance discarding request. Then, the instance control unit 120 transmits the instance discarding control request to the server 200.

Accordingly, the instance 210 is discarded.

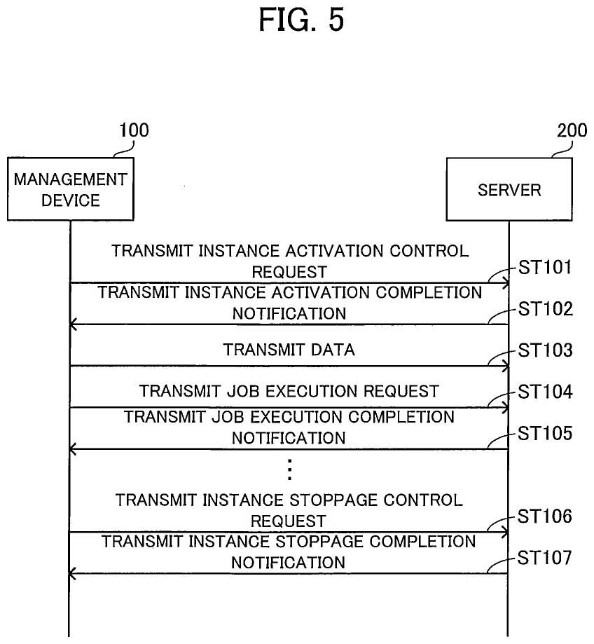

FIG. 5 is a sequence diagram of the process executed in the job execution system. FIG. 5 shows the process executed in FIG. 4 in the form of a sequence diagram.

(Step ST101) The management device 100 transmits the instance activation control request to the server 200.

(Step ST102) The server 200 transmits the instance activation completion notification to the management device 100.

(Step ST103) The management device 100 transmits the data to be used in the job to the server 200.

(Step ST104) The management device 100 transmits the job execution request to the server 200.

(Step ST105) The server 200 transmits the job execution completion notification to the management device 100.

The steps ST103 to ST105 are repeated until the job number decreases to 0.

(Step ST106) The management device 100 transmits the instance stoppage control request to the server 200.

(Step ST107) The server 200 transmits the instance stoppage completion notification to the management device 100.

FIG. 6 is a diagram showing an example (No. 2) of the time line in the job execution system. The process of FIG. 6 differs from the process of FIG. 4 in that steps S21 and S22 are executed. Thus, the steps S21 and S22 will be described below with reference to FIG. 6. Then, the description is omitted for the processing other than the steps S21 and S22.

The situation after the step S8 is as described below. The instance state is the activated state. The job execution state is the executing state. The connection state is the connected state since the management device 100 and the server 200 are in a state of being capable of communicating with each other.

At this point, the user turns off the power of the management device 100. Accordingly, the state of connection with the management device 100 shifts to the disconnected state. Incidentally, the shift to the disconnected state is caused also by a failure of the network 10.

(Step S21) The monitoring unit 220 monitors the state of connection with the management device 100 by using the PING command. For example, when a response to the PING command cannot be received, the monitoring unit 220 judges that the connection state is the disconnected state.

(Step S22) The instance control unit 230 executes the stoppage of the instance 210. Accordingly, the instance state shifts from the activated state to the stopping state. Then, when the stoppage of the instance 210 is completed, the instance state shifts from the stopping state to the stopped state.

When the state of connection with the management device 100 is the disconnected state, the server 200 stops the instance 210. Accordingly, the charging of the fee in the activated state stops. Alternatively, when the connection state is the disconnected state, the server 200 discards the instance 210. Accordingly, the charging of the fee in the activated state stops. Thus, according to the embodiment, the server 200 is capable of holding down the cost.

### DESCRIPTION OF REFERENCE CHARACTERS

10: network, 100: management device, 101: processor, 102: volatile storage device, 103: nonvolatile storage device, 110: job manager, 120: instance control unit, 130: notification unit, 200: server, 210: instance, 211: job execution agent, 220: monitoring unit, 230: instance control unit

1. An information processing device that receives a job execution request transmitted from a management device and indicating a request for executing a job, the information processing device comprising:
an instance that executes the job indicated by the job execution request;
monitoring circuitry to monitor a state of connection with the management device; and
instance controlling circuitry to execute stoppage of the instance or discarding of the instance when the instance is in operation or in an operable state and the connection state is a disconnected state.

2. The information processing device according to claim 1, wherein based on a first instance operating time transmitted from the management device and indicating an operating time for which the instance can operate, the monitoring circuitry judges that the connection state is the disconnected state when a second instance operating time as the next instance operating time is not received until elapse of the operating time.

3. The information processing device according to claim 1, wherein the instance includes at least one of the monitoring circuitry and the instance controlling circuitry.

4. A job execution system comprising:
a management device that transmits a job execution request indicating a request for executing a job; and
an information processing device that receives the job execution request,
wherein the information processing device includes:
an instance that executes the job indicated by the job execution request;
monitoring circuitry to monitor a state of connection with the management device; and
instance controlling circuitry to execute stoppage of the instance or discarding of the instance when the instance is in operation or in an operable state and the connection state is a disconnected state.

5. A control method performed by an information processing device that receives a job execution request transmitted from a management device and indicating a request for executing a job, the control method comprising:
monitoring a state of connection with the management device; and
executing stoppage of an instance that executes the job indicated by the job execution request or discarding of the instance when the instance is in operation or in an operable state and the connection state is a disconnected state.

6. An information processing device that receives a job execution request transmitted from a management device and indicating a request for executing a job, the information processing device comprising:
monitoring circuitry to monitor a state of connection with the management device; and
instance controlling circuitry to execute stoppage of an instance or discarding of the instance when the instance is in operation or in an operable state and the connection state is a disconnected state, the instance being an instance that executes the job indicated by the job execution request.

7. A job execution system comprising:
a management device that transmits a job execution request indicating a request for executing a job; and
an information processing device that receives the job execution request,
wherein the information processing device includes:
monitoring circuitry to monitor a state of connection with the management device; and
instance controlling circuitry to execute stoppage of an instance or discarding of the instance when the instance is in operation or in an operable state and the connection state is a disconnected state, the instance being an instance that executes the job indicated by the job execution request.
